(19) United States
(12) Patent Application Publication
(10) Pub. No.: US 2024/0066440 A1
(43) Pub. Date: Feb. 29, 2024

(54) FILTER DEVICE

(71) Applicant: Murata Manufacturing Co., Ltd., Nagaokakyo-shi (JP)

(72) Inventors: Tomoka YAMAMOTO, Nagaokakyo-shi (JP); Takashi KONDO, Nagaokakyo-shi (JP)

(21) Appl. No.: 18/365,379

(22) Filed: Aug. 4, 2023

(30) Foreign Application Priority Data
Aug. 24, 2022 (JP) 2022-133129
Jun. 15, 2023 (JP) 2023-098561

(51) Int. Cl. B01D 29/05; B01D 39/10

(52) U.S. Cl. CPC B01D 29/05; B01D 39/10; B01D 2239/1291

(57) ABSTRACT

A filter device that includes: a film section having multiple through-holes and a frame section surrounding a periphery of the film section; and a holding unit in a round or angular tubular shape, the holding unit having a groove on an inner wall of the holding unit that is constructed to hold the frame section of the filter. a size of the groove in an extending direction of the holding unit is larger than a thickness of the filter. A diameter of a first inscribed circle which contacts a surface of a recessed portion of the groove is larger than a second diameter of an inscribed circle which contacts an outer periphery of the filter.

### CROSS REFERENCE TO RELATED APPLICATIONS

The present application claims priority to Japanese Patent Application No. 2022-133129, filed Aug. 24, 2022, and Japanese Patent Application No. 2023-098561, filed Jun. 15, 2023, the entire contents of each of which are incorporated herein by reference.

### BACKGROUND OF THE INVENTION

### Field of the Invention

The present invention relates to a filter device.

### Description of the Related Art

International Publication No. 2018/092513 discloses a filter unit for separating cells from a liquid cell culture medium by filtering. This filter unit includes a metal porous film, a holding member, and a tubular member. The metal porous film separates cells from a liquid cell culture medium by filtering. The holding member holds a peripheral portion of the metal porous film. The tubular member is connected to the holding member.

### SUMMARY OF THE INVENTION

There is still room for improvement for the filter unit disclosed in the above-described publication in terms of reducing a load imposed on the filter and improving the filtering efficiency.

It is an object of the present invention to provide a filter device that is able to reduce a load on a filter and to improve the filtering efficiency.

According to an aspect of the invention, there is provided a filter device that separates a substance by filtering. The filter device includes: a filter including a film section having multiple through-holes and a frame section which surrounds the periphery of the film section; and a holding unit in a round or angular tubular shape. The holding unit having a groove on an inner wall of the holding unit that is constructed to hold the frame section of the filter. a size of the groove in an extending direction of the holding unit is larger than a thickness of the filter. As viewed in the extending direction of the holding unit, a diameter of a first inscribed circle which contacts a surface of a recessed portion of the groove is larger than a diameter of a second inscribed circle which contacts an outer periphery of the filter.

According to an embodiment of the invention, it is possible to provide a filter device that is able to reduce a load on a filter and to improve the filtering efficiency.

### BRIEF DESCRIPTION OF THE DRAWINGS

FIG. 1 is a schematic view illustrating a filter device according to a first embodiment of the invention;

FIG. 2A is a sectional view of the filter device taken along line A-A in FIG. 1;

FIG. 2B is an enlarged view of a region R1 shown in FIG. 2A;

FIG. 3 is a schematic view illustrating a portion of a film section of a filter;

FIG. 4 illustrates the portion of the film section shown in FIG. 3 as viewed in a Z direction;

FIG. 5 is a top view of the filter device shown in FIG. 1;

FIGS. 6A and 6B illustrate an operation of the filter device to be performed when a fluid is passing through the filter device;

FIG. 7 is a schematic view illustrating part of a filter device according to a first modified example of the first embodiment; and

FIG. 8 is a schematic view illustrating a filter device according to a second modified example of the first embodiment.

### DESCRIPTION OF THE PREFERRED EMBODIMENTS

Underlying Knowledge Forming Basis of the Invention

International Publication No. 2018/092513 discloses a liquid cell culture medium recovering filter unit including a metal porous film, a holding member, and a tubular member. The metal porous film separates cells from a liquid cell culture medium by filtering. The holding member holds the peripheral portion of the metal porous film. The tubular member is connected to the holding member.

In the liquid cell culture medium recovering filter unit disclosed in the above-described publication, in a hollow section of the holding member, which serves as a flow path, the flow velocity of a liquid cell culture medium near the inner wall of the holding member tends to become lower than that in the central portion of the hollow section due to the friction with the inner wall. This disturbs the uniformity of the flow velocity of the liquid cell culture medium acting on the metal porous film when the liquid cell culture medium passes through the filter. This causes the occurrence of clogging in the central portion of the metal porous film where the flow velocity is relatively high. As a result, the filtering efficiency is lowered. In the specification, the meaning of “improving the filtering efficiency” includes decreasing the filtering time and increasing the amount of fluid that can be processed by a filter.

Because of the occurrence of clogging in the metal porous film, an excessive level of pressure is applied to the clogged portion, thereby making the metal porous film vulnerable to breakage.

As a result of intensive and extensive research to address the above-described issues, the present inventors have conceived the following invention.

### First Embodiment

Overall Configuration

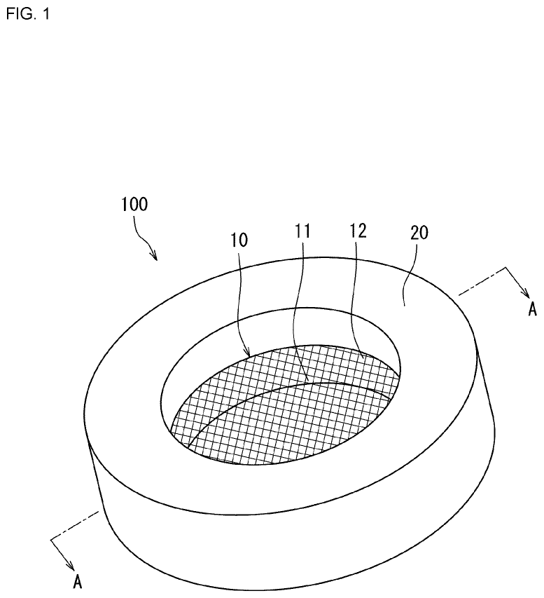

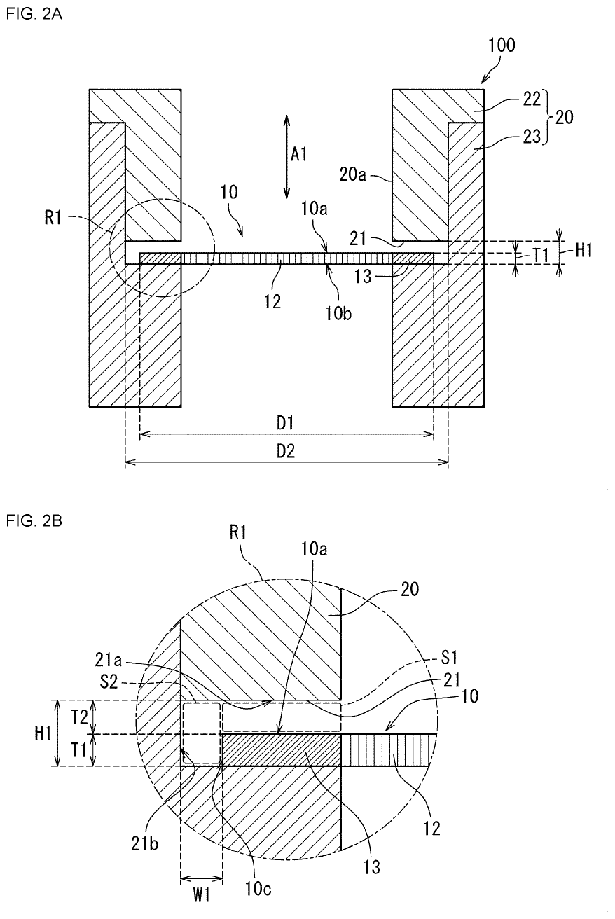

FIG. 1 is a schematic view illustrating a filter device 100 according to a first embodiment of the invention. FIG. 2A is a sectional view of the filter device 100 taken along line A-A in FIG. 1. FIG. 2B is an enlarged view of a region R1 shown in FIG. 2A. As illustrated in FIGS. 1 through 2B, the filter device 100 includes a filter 10 which separates a substance from a fluid by filtering and a holding unit 20 which holds the filter 10. The filter 10 includes a film section 12 having multiple through-holes 11 and a frame section 13 that surrounds the periphery of the film section 12. In the first embodiment, the frame section 13 of the filter 10 is supported by a groove 21 of the holding unit 20.

The filter device 100 causes a fluid containing a substance to pass therethrough so as to separate the substance from the fluid. Throughout the specification, the substance refers to a substance to be separated from a fluid by the filter 10. In the first embodiment, as the substance, a living-organism-derived substance is used, and as a fluid, a liquid is used.

In the specification, a living-organism-derived substance refers to a substance derived from a living organism, such as cells (eukaryotes), bacteria (eubacteria), and viruses. Examples of the cells (eukaryotes) are eggs, sperms, induced pluripotent stem cells (iPS cells), embryonic stem cells (ES cells), stem cells, mesenchymal stem cells, mononuclear cells, single cells, cell masses, suspension cells, adherent cells, nerve cells, white blood cells, lymphocytes, cells for regenerative medicine, autologous cells, cancer cells, circulating tumor cells (CTCs), HL-60 cells, HELA cells, and fungi. Examples of the bacteria (eubacteria) are gram-positive bacteria, gram-negative bacteria, Escherichia coli, and Mycobacterium tuberculosis. Examples of the viruses are DNA viruses, RNA viruses, rotaviruses, influenza viruses (avian flu viruses), yellow fever viruses, dengue fever viruses, encephalitis viruses, hemorrhagic fever viruses, and immunodeficiency viruses. In the first embodiment, in particular, the filter device 100 excels in separating iPS cells, ES cells, stem cells, and CTCs from liquids.

Filter

The filter 10 is a membrane filter which separates a living-organism-derived substance from a fluid by filtering. More specifically, the filter 10 includes a film section 12 having multiple through-holes 11 and a frame section 13 that surrounds the periphery of the film section 12. As illustrated in FIG. 1, in the first embodiment, the filter 10 is a structure formed in a circular metal mesh. The filter 10 has a pair of first and second main surfaces 10a and 10b opposing each other and is provided with multiple through-holes 11 passing through the first and second main surfaces 10a and 10b in the film section 12. The shape of the filter 10 is not limited to a circle. The filter 10 may be formed in an elliptical metal mesh. The multiple through-holes 11 are disposed regularly on the entirety of the first main surface 10a in the film section 12. The filter 10 is made of a metal, for example. Examples of the metal forming the filter 10 are gold, silver, copper, platinum, iron, nickel, chromium, stainless steel, palladium, titanium, and an alloy of such metals. In one example, the filter 10 traps a living-organism-derived substance. From this point of view, in terms of biocompatibility with a living-organism-derived substance, gold, nickel, stainless steel, titanium, or a nickel-palladium alloy is preferably used as the material for the filter 10. As the material for the filter 10, an elastic material having Young's modulus of 1 GPa or higher may be used.

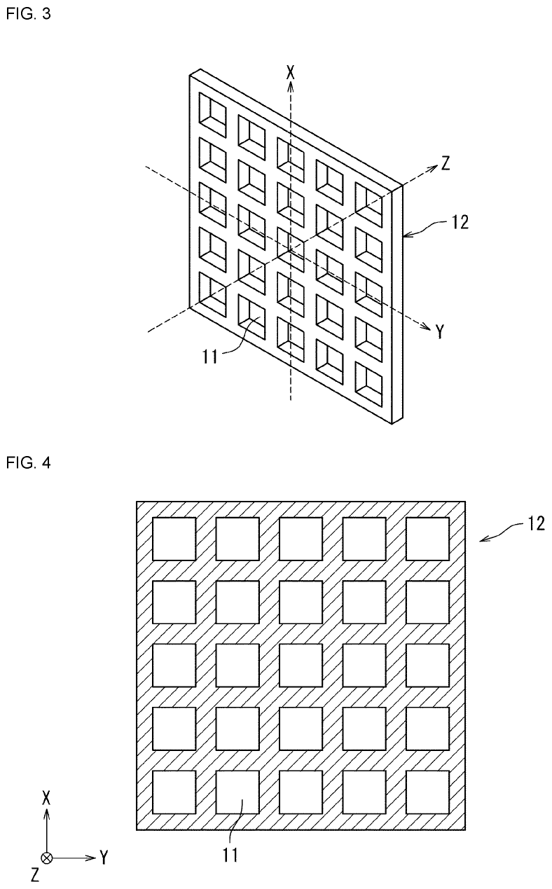

FIG. 3 is a schematic view illustrating a portion of the film section 12 of the filter 10. FIG. 4 illustrates the portion of the film section 12 shown in FIG. 3 as viewed in its thickness direction. The X, Y, and Z directions in FIGS. 3 and 4 respectively represent the vertical direction, horizontal direction, and thickness direction of the filter 10. As shown in FIGS. 3 and 4, the film section 12 may be a planar structure (lattice-like structure) in which the multiple through-holes 11 are disposed at regular intervals in a matrix form. The film section 12 is a planar structure provided with square through-holes 11 in a plan view of the main surfaces of the film section 12, that is, as seen in the Z direction. The plural through-holes 11 are equally spaced out in their two arranging directions, which are parallel with the sides of the square, that is, in the X direction and the Y direction in FIG. 3. Arranging the through-holes 11 in a square-lattice form can increase the opening area ratio of the filter 10 and lessen the load imposed on a fluid by the filter 10. The shape of the through-holes 11 is not limited to a square and may be another shape, such as a rectangle, a circle, and an ellipse. The arranging form of the through-holes 11 is not restricted to a square-lattice form. For example, the through-holes 11 may be arranged in a rectangular-lattice form in which the spacing in one arranging direction is different from that in the other arranging direction. Alternatively, the through-holes 11 may be arranged in a triangular-lattice form or be arranged quasi-regularly.

The dimensions of the filter 10 are suitably designed in accordance with the size and the shape of a living-organism-derived substance to be separated from a fluid by the filter 10. For example, the dimensions and the shape of the through-holes 11 are determined in accordance with the size and the shape of a living-organism-derived substance.

The through-holes 11 are formed in a square in a plan view of the main surfaces of the film section 12, that is, as seen in the Z direction. One side of the through-holes 11 is designed to be 0.01 to 500 μm. The spacing between the through-holes 11 is ten times as large as the size of the through-holes 11 or smaller, and more preferably, three times as large as the size of the through-holes 11 or smaller.

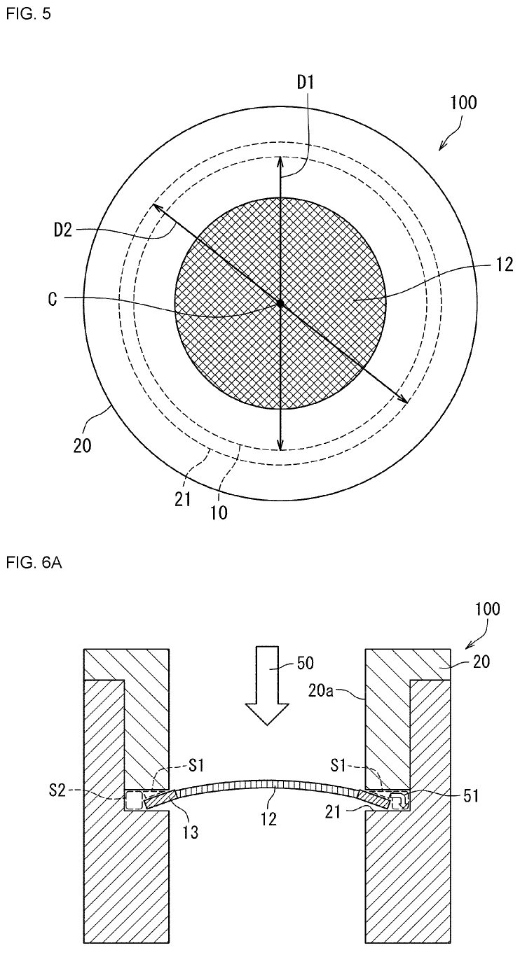

FIG. 5 is a top view of the filter device 100 shown in FIG. 1. The thickness T1 and the outer diameter D1 of the filter 10 shown in FIGS. 2A, 2B, and 5 are determined in accordance with the dimensions of the through-holes 11. If the size of one side of the through-holes 11 is 0.01 to 500 μm as described above, the thickness T1 of the filter 10 is 0.1 to 500 μm. Then, the aspect ratio of the size of the through-holes 11 to the thickness T1 of the filter 10 becomes 1 or smaller, thereby forming high-precision through-holes 11. The outer diameter D1 of the filter 10 is set to 5 to 500 mm. Setting the outer diameter D1 of the filter 10 to 5 mm or larger makes it possible to sufficiently bend the film section 12 when a fluid containing a substance to be separated passes through the filter 10. Setting the outer diameter D1 of the filter 10 to 500 mm or smaller can prevent the film section 12 from excessively bending and make it difficult for the filter 10 to drop from holding unit when a fluid containing a substance to be separated passes through the filter 10.

The void ratio of the filter 10 is preferably 10% to 90%, and more preferably, 20% to 50%. With this configuration, when a fluid containing a substance passes through the filter 10, the filter 10 can easily bend. At the same time, when a fluid does not pass through the filter 10, the filter 10 can be difficult to bend. The resistance of the filter 10 to a fluid can also be reduced. This can decrease the processing time and reduce a stress to cells.

The thickness of the frame section 13 of the filter 10 may be larger than that of the film section 12. This can enhance the strength of the filter 10. Through-holes, which are not shown, may be formed in the frame section 13. The through-holes formed in the frame section 13 may be fewer than the through-holes 11 in the film section 12. If the size of the through-holes in the frame section 13 is smaller than or equal to that of the through-holes 11 in the film section 12, a fluid containing a substance to be separated flows from a space S1 into the through-holes in the frame section 13. In this manner, because of the through-holes in the frame section 13, the pressure applied to the film section 12 can be relieved, thereby making it less likely to break the filter 10.

Holding Unit

The holding unit 20 holds the frame section 13 of the filter 10. As shown in FIG. 1, the holding unit 20 is formed in a cylindrical shape. The holding unit 20 may be made of a material having transparency, such as synthetic resin. Forming the holding unit 20 using a material having transparency enables a user to visually check the filter 10 supported by the holding unit 20 from the outside of the holding unit 20.

In the first embodiment, the holding unit 20 is constituted by a first member 22 and a second member 23. As illustrated in FIG. 2A, the first member 22 and the second member 23 are disposed so that the outer wall of the first member 22 and the inner wall of the second member 23 contact each other in the peripheral direction so as to form a space between the first member 22 and the second member 23 in an axial direction A1, which is the extending direction of the holding unit 20. The filter 10 is placed in this space.

As shown in FIG. 2A, a groove 21 is formed on an inner wall 20a of the holding unit 20 so as to hold the frame section 13 of the filter 10. As seen in the axial direction A1, the groove 21 is formed in a ring-like shape on the inner wall 20a of the holding unit 20 and is opened toward the filter 10.

As illustrated in FIG. 2B, the groove 21 is provided so that a space S1 is formed between the filter 10 and an inner wall 21a of the groove 21 and a space S2 is formed between the filter 10 and an inner wall 21b of the groove 21 when the groove 21 holds the filter 10. More specifically, the space S1 is formed between the main surface 10a of the filter 10 and the inner wall 21a of the groove 21 which faces the main surface 10a, while the space S2 is formed between an end portion 10c of the filter 10 and the inner wall 21b of the groove 21 which faces the end portion 10c. In other words, the size H1 of the groove 21 in the axial direction A1 indicated by the arrow A1, which is the extending direction of the holding unit 20, is larger than the thickness T1 of the filter 10. Additionally, as shown in FIG. 5, a diameter D2 of the groove 21 passing through an axis C of the holding unit 20 is larger than the outer diameter D1 of the filter 10, as viewed from above. In the first embodiment, the diameter D2 of the groove 21 represents the distance from a certain point on one side of the inner wall 21b of the groove 21 extending in the axial direction A1 to the other side of the inner wall 21b through the axis C. The inner wall 21b of the groove 21 is a surface of a recessed portion forming the groove 21. Accordingly, the diameter D2 of the groove 21 is the diameter of an inscribed circle which contacts the surface of the recessed portion forming the groove 21.

The provision of the spaces between the groove 21 and the filter 10 allows the filter 10 to move in the top-bottom direction and the left-right direction in FIG. 2A without being fixed to the groove 21. Additionally, when a fluid passes through the filter 10, the flow velocity of the fluid near the inner wall 20a of the holding unit 20 is less likely to decrease. This can reduce a difference in the flow velocity of a fluid between the central portion of the film section 12 and the vicinity of the inner wall 20a. The fluid is thus more likely to flow into the vicinity of the inner wall 20a of the holding unit 20, so that a substance contained in the fluid can be distributed over the entirety of the film section 12, thereby making the fluid easily flow through the filter 10. In the vicinity of the inner wall 20a of the holding unit 20 shown in FIG. 2A, the flow velocity of a fluid is lowered due to the friction with the inner wall 20a. A large amount of fluid thus tends to flow into the central portion of the film section 12. This facilitates the occurrence of clogging in the through-holes 11 at the central portion of the film section 12 compared with in the vicinity of the inner wall 20a. Because of the provision of the space S1, a fluid passing through the vicinity of the inner wall 20a of the holding unit 20 flows into the space S1, thereby increasing the flow velocity of the fluid near the inner wall 20a and distributing a flow of the fluid over the entirety of the film section 12. Because of the provision of the space S2, the fluid further flows from the space S1 to the space S2. That is, once the fluid flows into the space S1, it is less likely to flow backward. The fluid can thus pass through the film section 12 while being distributed over the entirety of the film section 12. What is more, due to a flow of the fluid from the film section 12 toward the space S1, the surface of the film section 12 is cleaned to remove the substance clogging the film section 12.

The position at which the space S1 is formed is different in accordance with the flowing direction of a fluid through the filter 10. More specifically, if a fluid flows from the top to the bottom in FIG. 2A, the space S1 is formed on the upstream side of the filter 10, that is, above the filter 10 in FIG. 2A. If a fluid flows from the bottom to the top in FIG. 2A, the space S1 is formed on the upstream side of the filter 10, that is, below the filter 10 in FIG. 2A.

The size H1 of the groove 21 in the axial direction A is 1.1 to 1.5 times as large as the thickness T1 of the filter 10, for example. This makes the size of the space S1, that is, a difference T2 between the size H1 of the groove 21 and the thickness T1 of the filter 10, be 0.01 to 250 μm. With this amount of difference T2, the filter 10 is less likely to drop from the holding unit 20 even when the filter 10 is bent. More preferably, the difference T2 between the size H1 of the groove 21 and the thickness T1 of the filter 10 is 0.5 to 150 μm. The size T2 of the space S1 may be 0.1 to 1.5 times as large as the dimension of the through-holes 11. If a substance to be separated from a fluid is larger than the through-holes 11, the size T2 of the space S1 is formed smaller than the substance. If a substance to be separated from a fluid is smaller than the through-holes 11, the size T2 of the space S1 is formed smaller than the through-holes 11. With this configuration, if a substance to be separated from a fluid is smaller than the through-holes 11, the fluid containing only this substance can pass through the through-holes 11. If a substance to be separated from a fluid is larger than the through-holes 11, the clogging in the film section 12 is less likely to occur. Since the filter 10 is supported by the groove 21 such that it can be movable in the axial direction A1, the size of the space S1 is varied while a fluid is passing through the film section 12. In the first embodiment, however, an explanation is given, assuming that the difference T2 between the size H1 of the groove 21 and the thickness T1 of the filter 10 is the size T2 of the space S1.

When the size T2 of the space S1 is larger than the size of the through-holes 11, and more specifically, when the size T2 of the space S1 is larger than the size of the through-holes 11 and is 1.5 times as large as the size of the through-holes 11 at the maximum, a fluid is more likely to flow into the space S1 than into the through-holes 11, which increases the flow velocity of the fluid at the peripheral portion of the film section 12. A flow of the fluid from the film section 12 to the space S1 is also generated. Since the fluid flows into the space S1, it can pass through the film section 12 while being distributed over the entirety of the film section 12. The pressure is thus applied relatively to the entirety of the film section 12, which makes it more likely to protect the film section 12 from a breakage. Even if the substance clogs the through-holes 11 near the inner wall 20a of the holding unit 12, it can be removed from the through-holes 11 due to the flow of the fluid toward the space S1. The clogging in the through-holes 11 can be cleared in this manner. The flow of the fluid toward the space S1 can also delay the occurrence of clogging in the film section 12.

In contrast, the size T2 of the space S1 may be smaller than or equal to the size of the through-holes 11, that is, the size T2 of the space S1 may be 0.1 to 1.0 times as large as the size of the through-holes 11. In this case, if the through-holes 11 near the inner wall 20a of the holding unit 20 are clogged and the pressure applied to the film section 12 exceeds a predetermined value, the fluid is caused to flow into the space S1 and the pressure applied to the film section 12 can be relieved. The film section 12 is thus less likely to be broken. When the size T2 of the space S1 is 0.01 μm or larger and is smaller than the size of a substance to be separated from a fluid, only the fluid can flow into the space S1. This makes it difficult for the substance to clog the space S1 and the pressure applied to the film section 12 can be eased for a longer time. Additionally, due to the capillary action, air bubbles smaller than the size of the through-holes 11 can be trapped in the space S1.

The diameter D2 of the groove 21 is 1.002 to 1.1 times as large as the outer diameter D1 of the filter 10, for example. A half of the difference between the diameter D2 of the groove 21 and the outer diameter D1 of the filter 10 may be 0.2 to 2 times as large as the size of the through-holes 11. If the size W1 of the space S2 is larger than the size of the through-holes 11, the filter 10 may easily drop from the holding unit 20. A smaller value is thus set as the size W1 of the space S2 than the size of the through-holes 11. With this configuration, the size W1 of the space S2, that is, a half of the difference between the diameter D2 of the groove 21 and the outer diameter D1 of the filter 10 is 0.02 to 500 μm, and more preferably, 0.05 to 200 μm. As well as the size of the space S1, the size W1 of the space S2 is varied while a fluid is passing through the film section 12. In the first embodiment, however, an explanation is given, assuming that a half of the difference between the diameter D2 of the groove 21 and the outer diameter D1 of the filter 10 is the size W1 of the space S2.

The provision of the space S2 prevents a fluid flowing into the space S1 from flowing backward and causes it to flow into the space S2. The fluid is thus less likely to remain in the space S1 and can flow while being distributed over the entirety of the film section 12. The filter 10 is movable in the top-bottom direction, which can facilitate the flowing of the fluid into the space S2, thereby further enhancing the distribution of the fluid. Because of the provision of the space S2, instruments, such as tweezers, can be inserted into the space S2. Hence, the filter 10 supported by the holding unit 20 can be gripped without being damaged.

The size W1 of the space S2 is larger than or equal to the size T2 of the space S1. More specifically, a half of the difference between the diameter D2 of the groove 21 and the outer diameter D1 of the filter 10, that is, the size W1 of the space S2, is larger than or equal to the difference T2 between the size H1 of the groove 21 in the axial direction A1 and the thickness T1 of the filter 10. Forming the space S2 larger than or equal to the space S1 can relieve the pressure applied to the film section 12 more easily. The effects of the space S1 can thus be maintained.

Operation of Filter Device

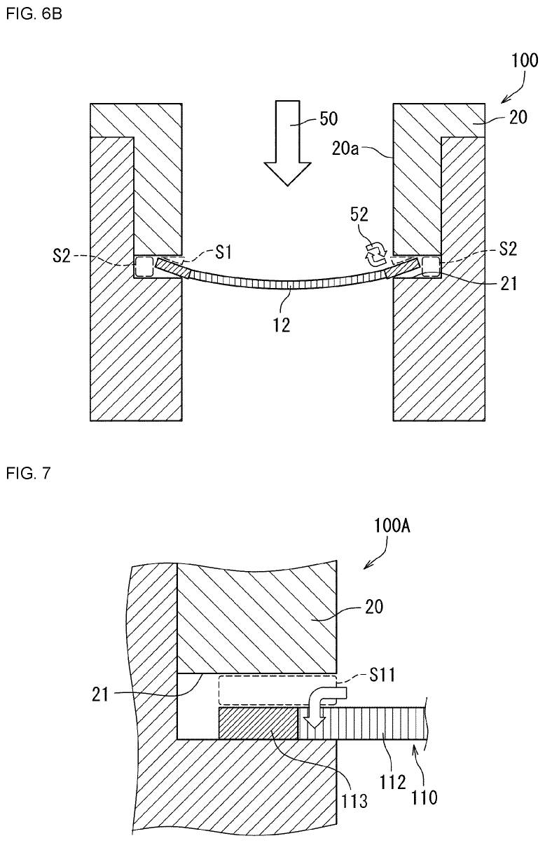

FIGS. 6A and 6B illustrate an operation of the filter device 100 to be performed when a fluid is passing through the filter 10. The arrow 50 in FIGS. 6A and 6B indicates a flow of a fluid from the upstream to downstream side. As shown in FIGS. 6A and 6B, in the filter device 100, when a fluid containing a substance to be separated by the filter 10 passes through the filter 10 in the direction indicated by the arrow 50, the central portion of the film section 20 of the filter 10 moves up and down in the axial direction of the film section 20. In other words, the filter 10 bends and the central portion of the film section 12 vibrates in the axial direction. At this time, the frame section 13 supported by the groove 21 axially vibrates in a reverse direction of the vibrating direction of the film section 12. In this manner, while the fluid is passing through the filter 10, the filter 10 moves up and down in the flowing direction of the fluid while being bending.

While the frame section 13 is moving in the axial direction, the size and the shape of the space S1 are changing. This generates a flow of the fluid heading from the space S1 toward the space S2, as indicated by the arrow 51 in FIG. 6A, and the fluid is less likely to flow backward from the space S1. As a result of the size and the shape of the space S1 changing, a stream is generated, as indicated by the arrow 52 in FIG. 6B, at the opening of the groove 21. This encourages the substance in the fluid to enter the space S1 and to exit from the space S1, thereby reducing the occurrence of clogging of the substance in the spaces S1 and S2. Because of the provision of the space S1, the frame section 13 can move up and down in the groove 21 while the filter 10 is bending. The frame section 13 is thus less likely to warp, thereby reducing the load on the frame section 13.

In the first embodiment, since the holding unit 20 is made of a material having transparency as discussed above, a user can visually check the filter 10 from the outside of the holding unit 20. When a fluid passes through the filter device 100, a backward current or a swirling current may occur, which may prevent the fluid from flowing in a desired direction. Since the filter 10 is supported by the groove 21 such that it is movable, a user can check the movement of the filter 10 from the outside of the holding unit 20 so as to detect in which direction the fluid is flowing.

Advantages

A filter device 100 according to the first embodiment achieves the following advantages.

The filter device 100 that separates a substance from a fluid by filtering includes filter 10 and a holding unit 20. The filter 10 includes a film section 12 having multiple through-holes 11 and a frame section 13 which surrounds the periphery of the film section 12. The holding unit 20 is formed in a cylindrical shape. A ring-like groove 21 is formed on an inner wall 20a of the holding unit 20 so as to hold the frame section 13 of the filter 10. The size H1 of the groove 21 in the axial direction A1, which is the extending direction of the holding unit 20, is larger than the thickness T1 of the filter 10. The diameter D2 of the groove 21 is larger than the outer diameter D1 of the filter 10.

With this configuration, the load on the filter 10 can be reduced and the filtering efficiency can be improved. The meaning of improving the filtering efficiency includes decreasing the filtering time and increasing the amount of fluid that can be processed by the filter 10, for example. When the frame section 13 of the filter 10 is placed in the groove 21, spaces S1 and S2 are formed between the filter 10 and the groove 21. A fluid flows into these spaces S1 and S2. This can reduce a difference in the flow velocity between the portion of the film section 12 near the inner wall 20a of the holding unit 20 and the central portion of the film section 12, thereby distributing the pressure over the entirety of the film section 12 of the filter 10. It is thus possible to reduce the load on the filter 10 and to improve the filtering efficiency. Additionally, due to the provision of the spaces S1 and S2, the filter 10 can move in the top-bottom direction and the left-right direction in FIG. 2A, thereby distributing a load imposed on the film section 12. The provision of the spaces S1 and S2 can also place the filter 10 in the holding unit 20 without warping the filter 10, that is, without imposing a load on the filter 10.

The thickness T1 of the filter 10 is 0.1 to 500 μm. The size H1 of the groove 21 in the axial direction A1 is 1.1 to 1.5 times as large as the thickness T1 of the filter 10. With this configuration, when a fluid is flowing through the filter device 100, the filter 10 vibrates up and down while being bending. This can remove a substance contained in the fluid from the through-holes 11 while causing the fluid to flow.

The difference T2 between the size H1 of the groove 21 in the axial direction A1 and the thickness T1 of the filter 10 may be 0.1 to 1.5 times as large as the size of the through-holes 11. If a substance to be separated from a fluid by the filter 10 is larger than the through-holes 11, the size T2 of the space S1 is formed smaller than the substance. If a substance to be separated from a fluid by the filter 10 is smaller than the through-holes 11, the size T2 of the space S1 is formed smaller than the through-holes 11. With this configuration, when the size T2 of the space S1 is larger than the size of the through-holes 11, a fluid flows into the space S1, thereby distributing the pressure applied to the film section 12. In contrast, when the size T2 of the space S1 is smaller than the size of the through-holes 11, air bubbles smaller than the size of the through-holes 11 can be trapped in the space S1. The space S1 does not serve as a flow path until the through-holes 11 of the film section 12 are clogged. However, when the through-holes 11 are clogged, the space S1 can serve as a flow path. This can relieve the pressure applied to the film section 12, and the film section 12 is less likely to be broken.

The outer diameter D1 of the filter 10 may be 5 to 500 mm. The diameter D2 of the groove 12 may be 1.002 to 1.1 times as large as the outer diameter D1 of the filter 10. However, to prevent the filter 10 from dropping from the holding unit 20, a smaller value is preferably set as the size W1 of the space S2 than the size of the through-holes 11. This can generate a flow of a fluid heading from the space S1 to the space S2, thereby making it difficult to clog the through-holes 11. As a result, a substance can be separated from the fluid efficiently.

A half of the difference between the diameter D2 of the groove 21 and the outer diameter D1 of the filter 10 may be 0.2 to 2 times as large as the size of the through-holes 11. This can generate a flow of a fluid heading from the space S1 to the space S2, thereby maintaining the effect of distributing the pressure applied to the film section 12 of the filter 10.

The difference T2 between the size H1 of the groove 21 in the axial direction A1 and the thickness T1 of the filter 10 is smaller than a half of the difference between the diameter D2 of the groove 21 and the outer diameter D1 of the filter 10. This can generate a flow of a fluid heading from the space S1 to the space S2, thereby easing the pressure applied to the film section 12.

The holding unit 20 includes a first member 22 and a second member 23, and the filter 10 is disposed in a space formed between the first member 22 and the second member 23. With this configuration, the filter device 10 can be assembled easily.

The filter 10 is made of a metal. The filter 10 is thus less likely to be broken. When a fluid passes through the film section 12, the through-holes 11 are difficult to be deformed. With this configuration, a substance in the fluid is less likely to pass through the film section 12, which would otherwise occur by the deformation of the through-holes 11.

In the above-described embodiment, the holding unit 20 is formed in a cylindrical shape by way of example. However, the holding unit 20 is not restricted to this shape and may be formed in a tubular shape other than a cylindrical shape. For example, the holding unit 20 may be formed in a tubular shape having a polygonal section. In this modification, as viewed in the axial direction A1, the diameter of an inscribed circle which contacts the inner periphery of the groove is formed larger than the diameter of an inscribed circle which contacts the outer periphery of the filter. In this case, the difference between the size of the groove in the axial direction A1, which is the extending direction of the holding unit, and the thickness of the filter may be smaller than a half of the difference between the diameter of the inscribed circle of the groove and that of the inscribed circle on the outer periphery of the filter. If the filter is circular, the diameter of the inscribed circle on the outer periphery of the filter is the outer diameter of the filter.

In the above-described embodiment, the frame section 13 of the filter 10 is held in the groove 21 of the holding unit 20 by way of example. However, this configuration is only an example. FIG. 7 is a schematic view illustrating part of a filter device 100A according to a first modified example of the first embodiment. As illustrated in FIG. 7, in addition to a frame section 113 of a filter 110, part of a film section 112 may also be held in a groove 21.

As a result of part of the film section 112 being supported by the groove 21, a fluid flowing into a space S11 flows into the through-holes formed in the film section 112 supported by the groove 21, which lowers the flow velocity of the fluid. Accordingly, the through-holes near the inner wall 20a are less likely to be clogged than those at the central portion of the film section 112. Even if a substance contained in the fluid clogs the central portion of the film section 112, the through-holes formed in the film section 112 supported by the groove 21 can help relieve the pressure applied to the central portion of the film section 112.

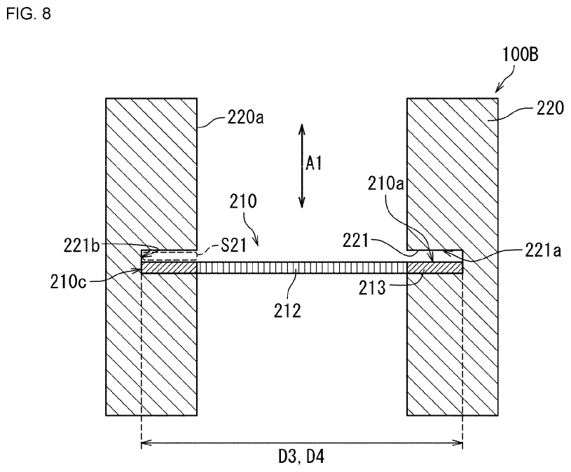

FIG. 8 is a schematic view illustrating a filter device 100B according to a second modified example of the first embodiment. As illustrated in FIG. 8, the formation of a space between an end portion 210c of a filter 210 and an inner wall 221b of a groove 221 facing the end portion 210c may be omitted. In other words, the outer diameter D3 of the filter 210 and the diameter D4 of the groove 221 may be formed substantially in the same size. In this case, a space S21 is formed between one main surface 210a of the filter 210 and an inner wall 221a of the groove 221 facing the main surface 210a. A frame section 213 is held in the groove 221.

With this configuration, a fluid flowing along an inner wall 220a of a holding unit 220 can easily flow into the space S21. This can raise the flow velocity of the fluid flowing along the inner wall 220a and distribute the pressure applied to a film section 212. As a result, the film section 212 is less likely to be broken. Additionally, due to the friction between the inner wall 221b of the groove 221 and the end portion 210c of the filter 210, the movement of the filter 210 in the top-bottom direction is restricted, thereby fixing the size of the space S21. Vibration of the film section 212 in the axial direction A1 is also restricted, which reduces the load imposed on the film section 212. As a result, the film section 212 is less likely to be broken.

In the above-described embodiment, the difference T2 between the size H1 of the groove 21 in the axial direction A1 and the thickness T1 of the filter 10 is smaller than a half of the difference between the diameter D2 of the groove 21 and the outer diameter D1 of the filter 10. However, this configuration is only an example. The difference T2 between the size H1 of the groove 21 in the axial direction A1 and the thickness T1 of the filter 10 may be larger than a half of the difference between the diameter D2 of the groove 21 and the outer diameter D1 of the filter 10. In other words, the difference T2 between the size H1 of the groove 21 in the axial direction A1, which is the extending direction of the holding unit 20, and the thickness T1 of the filter 10 may be larger than a half of the difference between the diameter of an inscribed circle of the groove 21 and that of an inscribed circle on the outer periphery of the filter 10.

Conclusions of Embodiment

(1) A filter device according to an aspect of the invention is a filter device that separates a substance by filtering. The filter device includes: a filter including a film section having multiple through-holes and a frame section which surrounds a periphery of the film section; and a holding unit in a round or angular tubular shape, the holding unit having a groove on an inner wall of the holding unit that is constructed to hold the frame section of the filter. A size of the groove in an extending direction of the holding unit is larger than a thickness of the filter. As viewed in the extending direction of the holding unit, a diameter of a first inscribed circle which contacts a surface of a recessed portion of the groove is larger than a diameter of a second inscribed circle which contacts an outer periphery of the filter.

(2) In the filter device of (1): the holding unit may be formed in a round or angular tubular shape; the groove may be formed in a circular-ring-like shape; the filter may be formed in a circular shape; and a diameter of the groove may be larger than an outer diameter of the filter.

(3) In the filter device of (1) or (2): the thickness of the filter may be 0.1 to 500 μm; and the size of the groove in the extending direction of the holding unit may be 1.1 to 1.5 times as large as the thickness of the filter. With this configuration, the pressure applied to the film section can be distributed, thereby making it more likely to protect the film section from a breakage.

(4) In the filter device of one of (1) to (3), a difference between the size of the groove in the extending direction of the holding unit and the thickness of the filter may be 0.1 to 1.5 times as large as a size of a through-hole of the plurality of through-holes. With this configuration, if the difference between the size of the groove in the extending direction of the holding unit and the thickness of the filter is larger than the through-holes, it makes it more likely to protect the film section from a breakage, and the clogging in the through-holes near the inner wall of the holding unit can be cleared. If the difference between the size of the groove in the extending direction of the holding unit and the thickness of the filter is smaller than the through-holes, the pressure applied to the film section can be relieved, and air bubbles smaller than the size of the through-holes can be trapped.

(5) In the filter device of one of (2) to (4): the outer diameter of the filter may be 5 to 500 mm; and the diameter of the groove may be 1.002 to 1.1 times as large as the outer diameter of the filter. With this configuration, a flow of a fluid heading from the filter to a space between the filter and the groove can be generated, thereby making it difficult to clog the through-holes.

(6) In the filter device of one of (2) to (5), a half of a difference between the diameter of the groove and the outer diameter of the filter may be 0.2 to 2 times as large as a size of a through-hole of the plurality of through-holes. With this configuration, a flow of a fluid heading from the filter to a space between the filter and the groove can be generated, thereby maintaining the effect of distributing the pressure applied to the film section.

(7) In the filter device of one of (2) to (6), a difference between the size of the groove in the extending direction of the holding unit and the thickness of the filter may be smaller than a half of a difference between the diameter of the first inscribed circle and the diameter of the second inscribed circle. With this configuration, a flow of a fluid heading from the filter to a space between the filter and the groove can be generated, thereby relieving the pressure applied to the film section.

(8) In the filter device of one of (2) to (6), a difference between the size of the groove in the extending direction of the holding unit and the thickness of the filter may be smaller than a half of a difference between the diameter of the groove and the outer diameter of the filter.

(9) In the filter device of one of (1) to (8), part of the film section may be placed in the groove. With this configuration, even if a substance contained in a fluid clogs the central portion of the film section, the through-holes formed in the film section supported by the groove can help relieve the pressure applied to the central portion of the film section.

(10) In the filter device of one of (1) to (9), the holding unit may include a first member and a second member, and the filter may be disposed in a space formed between the first member and the second member.

(11) In the filter device of one of (1) to (10), the filter may be made of a metal. The filter is thus less likely to be broken.

The invention pertains to a filter device that separates a substance from a fluid by filtering. This filter device is excellent in terms of improving the filtering efficiency. The filter device can be used for medical diagnosis by removing cells from a biological specimen, for example, and can also be used for taking environmental protection measures by trapping PM2.5 particles from air, for example.

What is claimed is:

1. A filter device that separates a substance by filtering, the filter device comprising:
a filter including a film section and a frame section, the film section having a plurality of through-holes, the frame section surrounding a periphery of the film section; and
a holding unit in a round or angular tubular shape, the holding unit having a groove on an inner wall of the holding unit that is constructed to hold the frame section of the filter, wherein
a size of the groove in an extending direction of the holding unit is larger than a thickness of the filter, and
as viewed in the extending direction of the holding unit, a diameter of a first inscribed circle which contacts a surface of a recessed portion of the groove is larger than a diameter of a second inscribed circle which contacts an outer periphery of the filter.

2. The filter device according to claim 1, wherein:
the holding unit has a cylindrical shape;
the groove has a circular-ring shape;
the filter has a circular shape; and
a diameter of the groove is larger than an outer diameter of the filter.

3. The filter device according to claim 1, wherein:
the thickness of the filter is 0.1 to 500 μm; and
the size of the groove in the extending direction of the holding unit is 1.1 to 1.5 times as large as the thickness of the filter.

4. The filter device according to claim 3, wherein a difference between the size of the groove in the extending direction of the holding unit and the thickness of the filter is 0.1 to 1.5 times as large as a size of a through-hole of the plurality of through-holes.

5. The filter device according to claim 2, wherein:
the outer diameter of the filter is 5 to 500 mm; and
the diameter of the groove is 1.002 to 1.1 times as large as the outer diameter of the filter.

6. The filter device according to claim 5, wherein a half of a difference between the diameter of the groove and the outer diameter of the filter is 0.2 to 2 times as large as a size of a through-hole of the plurality of through-holes.

7. The filter device according to claim 1, wherein a difference between the size of the groove in the extending direction of the holding unit and the thickness of the filter is smaller than a half of a difference between the diameter of the first inscribed circle and the diameter of the second inscribed circle.

8. The filter device according to claim 2, wherein a difference between the size of the groove in the extending direction of the holding unit and the thickness of the filter is smaller than a half of a difference between the diameter of the groove and the outer diameter of the filter.

9. The filter device according to claim 1, wherein part of the film section is in the groove.

10. The filter device according to claim 1, wherein the holding unit includes a first member and a second member, and the filter is disposed in a space between the first member and the second member.

11. The filter device according to claim 10, wherein the first member and the second member are disposed so that an outer wall of the first member and an inner wall of the second member contact each other in a peripheral direction of the holding unit, and the space between the first member and the second member is in an axial direction of the holding unit.

12. The filter device according to claim 1, wherein the filter is made of a metal.

13. The filter device according to claim 1, wherein the filter has a void ratio of 10% to 90%.

14. A filter device that separates a substance by filtering, the filter device comprising:
a filter including a film section and a frame section, the film section having a plurality of through-holes, the frame section surrounding a periphery of the film section; and
a holding unit in a round or angular tubular shape, the holding unit having a groove on an inner wall of the holding unit that is constructed to hold the frame section of the filter, wherein
a size of the groove in an extending direction of the holding unit is larger than a thickness of the filter, and
as viewed in the extending direction of the holding unit, an outer diameter of the filter and a diameter of the groove are substantially the same size.

15. The filter device according to claim 14, wherein:
the holding unit has a cylindrical shape;
the groove has a circular-ring shape; and
the filter has a circular shape.

16. The filter device according to claim 14, wherein a difference between the size of the groove in the extending direction of the holding unit and the thickness of the filter is smaller than a half of a difference between the diameter of the groove and the outer diameter of the filter.

17. The filter device according to claim 15, wherein a difference between the size of the groove in the extending direction of the holding unit and the thickness of the filter is smaller than a half of a difference between the diameter of the groove and the outer diameter of the filter.

18. The filter device according to claim 14, wherein the holding unit includes a first member and a second member, and the filter is disposed in a space between the first member and the second member.

19. The filter device according to claim 18, wherein the first member and the second member are disposed so that an outer wall of the first member and an inner wall of the second member contact each other in a peripheral direction of the holding unit, and the space between the first member and the second member is in an axial direction of the holding unit.

20. The filter device according to claim 14, wherein the filter is made of a metal.
